(19) United States
(12) Patent Application Publication
(10) Pub. No.: US 2008/0140915 A1
(43) Pub. Date: Jun. 12, 2008

(54) Memory Card System and Method for Transferring Lifetime Information Thereof

(76) Inventors: Won-Chul Ju, Seoul (KR); Tae Hyun Yoon, Seoul (KR)

Correspondence Address: F. CHAU & ASSOCIATES, LLC, 130 WOODBURY ROAD, WOODBURY, NY, 11797, US

(21) Appl. No.: 11/694,394

(22) Filed: Mar. 30, 2007

(30) Foreign Application Priority Data
Dec. 8, 2006 (KR) 2006-124947

(51) Int. Cl. G06F 12/02

(52) U.S. Cl. 711/103; 711/115

(57) ABSTRACT

A memory card system and method of transmitting lifetime information thereof includes a host generating a lifetime information command, and a memory card including a memory to store data provided from the host, the memory card providing the host with lifetime information of the memory in response to the lifetime information command of the host.

### CROSS-REFERENCE TO RELATED APPLICATIONS

This U.S. non-provisional patent application claims priority under 35 U.S.C § 119 of Korean Patent Application No. 2006-124947 filed on Dec. 8, 2006, the entire contents of which are hereby incorporated by reference.

### BACKGROUND

1. Field of the Invention

The present invention disclosed herein relates to memory card systems and more particularly, to a memory card system transferring lifetime information of a memory.

2. Description of Related Art

Memory cards, e.g., Secure Digital (SD) cards, Multi-Media Cards (MMCs), eXtreme Digital (xD) cards, Compact Flash (CF) cards, Smart Media (SM) cards, and memory sticks, are widely used with electronic host devices. Exemplary host devices include mobile phones, MP3 players, portable media players (PMPs), digital cameras, and so on.

FIG. 1 is a block diagram of a memory card system. Referring to FIG. 1, the memory card system 1 includes a host 10 and a memory card 20. The host 10 has a host controller 11 and a host connection unit 12. The memory card 20 includes a card connection unit 21, a card controller 22, and a memory 23.

The host 10 writes data into the memory card 20 or reads data from the memory card 20. The host controller 11 transfers a command (e.g., a write command), a clock signal CLK generated from an internal clock generator (not shown), and data DAT to the memory card 20 by way of the host connection unit 12.

The card controller 22 stores the data into the memory 23 in synchronization with the clock signal output from a clock generator (not shown) of the card controller 22 in response to a write command received through the card connection unit 21. The memory 23 stores data transferred from the host 10. For example, the memory 23 stores image data when the host 10 is a digital camera. While there are many kinds of memories, the memory 23 is typically used with a flash memory.

A lifetime of a flash memory is typically determined by the number of erasing-programming cycles. The lifetime of the memory card 20 is dependent of the lifetime of the flash memory embedded therein. Typically in the memory card 20, data provided from the host 10 are uniformly programmed all over the flash memory 23. The memory card 20 inhibits the repetition of erase and write operations on a specific region of the flash memory 23. The lifetime of the memory card becomes shorted if the erase and write operations are repeated on a specific region of the flash memory 23.

Inhibiting the repetition of erase and write operations on a specific region for managing a lifetime of the flash memory 23 is called ‘wear leveling’. The memory card 20 implements the wear leveling operation for regulating the erase and write operations to uniformly use a cell array of the flash memory 23. By implementing the wear leveling operation, a lifetime of the memory card 20 can be extended as compared to a case where wear leveling is not implemented.

The lifetime of the memory card 20 varies with the kind of the flash memory 23, regardless of the wear leveling operation. For example, a lifetime of the memory card 20 varies in accordance with whether the flash memory 23 has multi-level cells (MLCs), each of which stores multi-bit data per cell, or single-level cells (SLCs), each of which stores a single-bit data.

In addition, a lifetime of the memory card 20 varies with lifetime information such as a use term, a usage rate, a capacity, and a version. The memory card system 1 does not identify the lifetime information of the flash memory 23.

Therefore, a need exists for a memory card system and method for transferring lifetime information of a memory.

### SUMMARY OF THE INVENTION

According to an embodiment of the present invention a memory card system includes a host generating a lifetime information command, and a memory card including a memory to store data provided from the host, the memory card providing the host with lifetime information of the memory in response to the lifetime information command of the host.

According to an embodiment of the present invention, the memory card is an SD card or an MMC. The host transfers the lifetime information command to the memory card through a command line. The memory card transfer the lifetime information to the host through the command line. The memory card transfer the lifetime information to the host through a data line. The memory card includes a lifetime information storage unit for storing the lifetime information of the memory or stores the lifetime information into the memory.

According to an embodiment of the present invention a method for transmitting lifetime information in a memory card system including a host and a memory card having a memory for storing data from the host includes transferring a command for requesting lifetime information from the memory card by the host, and providing the host with the lifetime information of the memory in response to the command.

According to an embodiment for the present invention, the memory card is provided as one of an SD card or an MMC. The host transfers the command to the memory card through a command line. The memory card transfers the lifetime information to the host through the command line or a data line. The lifetime information of the memory is stored into the memory of a lifetime information storage unit of the memory card.

### BRIEF DESCRIPTION OF THE FIGURES

Non-limiting and non-exhaustive embodiments of the present invention will be described with reference to the following figures, wherein like reference numerals refer to like parts throughout the various figures unless otherwise specified. In the figures:

FIG. 1 is a block diagram of a general memory card system;

FIG. 2 shows an outer configuration of an SD card;

FIG. 3 shows an arrangement of pins with respective descriptions in the defined in FIG. 3;

FIG. 4A and 4B show formats of the command and response which are defined in FIG. 3;

FIG. 5A through 5C show a scheme of transferring lifetime information in a memory card system according to an embodiment of the present invention; and

FIGS. 6A and 6B show another embodiment of transferring lifetime information in a memory card system according to an embodiment of the present invention.

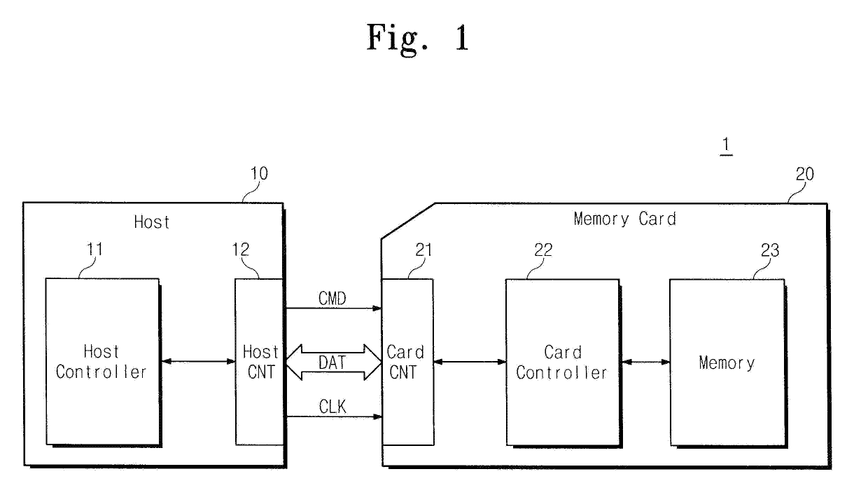

### DETAILED DESCRIPTION OF PREFERRED EMBODIMENTS

Preferred embodiments of the present invention will be described below in more detail with reference to the accompanying drawings. The present invention may, however, be embodied in different forms and should not be constructed as limited to embodiments set forth herein. Rather, embodiments are provided so that this disclosure will be thorough and complete, and will fully convey the scope of the present invention to those skilled in the art. Like reference numerals refer to like elements throughout the accompanying figures.

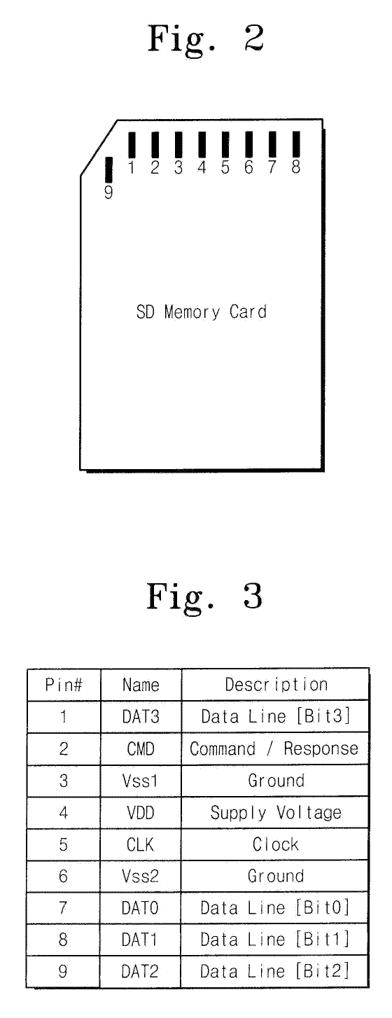

FIG. 2 shows an outer configuration of an SD card, and FIG. 3 shows an arrangement of pins with respective descriptions in the SD card. Referring to FIG. 2, the SD card includes nine pins. As shown in FIG. 3, the SD card has four data pins (pin #: 1, 7, 8, and 9), one command pin (pin #: 2), one clock pin (pin #: 5), and three power pins (pine #: 3, 4, and 6).

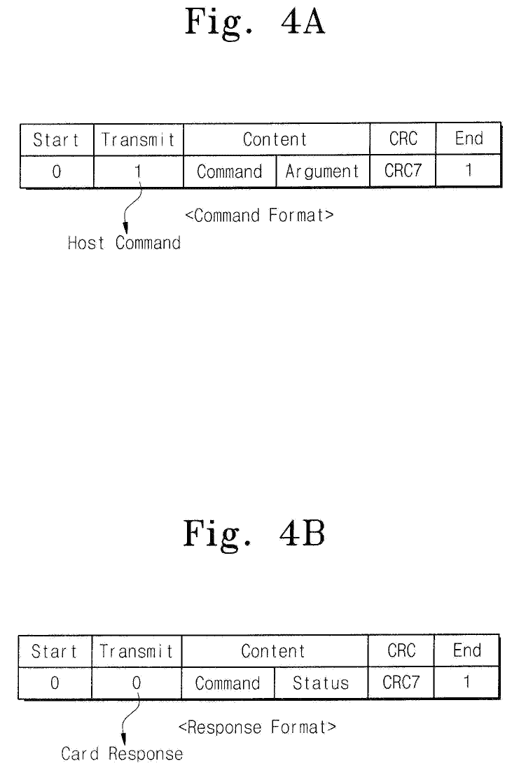

A command and a response are transferred through the command pin (pin #: 2), Typically, the command is transferred to the memory card from a host and the response is transferred to the host from the memory card. A format of the command and response will be detailed in conjunction with FIG. 4.

FIGS. 4A and 4B show formats of the command and response, respectively, which are defined in FIG. 3.

Referring to FIG. 4A, the command format includes a start bit, a transmission bit (Transmit), a content block, a cyclic redundancy check (CRC) code, and an end bit. It is assumed that the command format includes 48 bits.

The command format begins with the start bit. The start bit is normally defined in ‘0’. The transmission bit is provided to define a direction of transmission. If the transmission bit is ‘1’, data is transferred toward the memory card from the host. If the transmission bit is ‘1’, data is transferred toward the host from the memory card.

The content block includes a command and an argument. The command is formed of 6 bits for example. This 6-bit command may be decoded into 64 commands. One or more of the 64 commands may need an argument (e.g., an address). The argument is formed of 32 bits as an example. All commands are protected by the CRC code. The CRC code is formed of 7 bits as an example. The end bit is provided to terminate transmission of the command. The end bit is typically defined in ‘1’.

Referring to FIG. 4B, the response format includes a start bit, a transmission bit, a content block, a CRC code, and an end bit. As illustrated in FIGS. 4A and 4B, the response format is substantially similar to the command format.

The response format normally begins with the start bit ‘0’ that is follows by the transmission bit ‘0’. The content block includes a command and a status signal. The command is formed of 6 bits and the status signal is formed of 32 bits. The status signal is provided to inform the host of a current state of the memory card.

As aforementioned, the memory card system operates with a command transferred to the memory card from the host, a response transferred to the host form the memory card, and data exchanged between the host and the memory card. A memory card such as an MMC or an SD card is initialized by means of an identification mode. During the initialization, the host obtains a variety of host identification information such as a storage capacity, a maker, and a serial number of the memory card.

The memory card system according to an embodiment of the present invention, during or after initialization, conducts a process for transferring lifetime information of the memory card. According to an embodiment of the present invention, a lifetime of the memory card may be managed using lifetime information requested from the memory card by the host and transferring to the host.

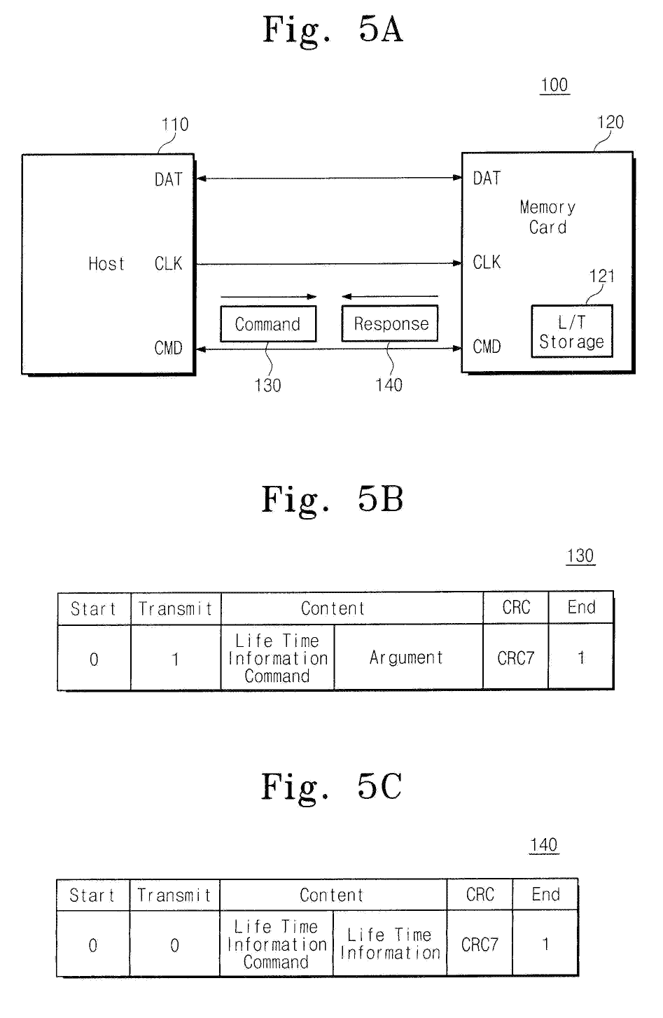

FIGS. 5A through 5C show a system and method of transferring lifetime information in the memory card system according to an embodiment of the present invention. Referring to FIG. 5A, the memory card system 100 includes a host 110 and a memory card 120. The host 110 is electrically connected with the memory card 120 by way of a data line, a clock line, and command line.

The host 110 transfers a specific command 130 to the memory card 120 through the command line for requesting lifetime information from the memory card 120. Referring to FIG. 5B, the specific command 130 includes a lifetime information command. The lifetime information command is defined to request lifetime information from the memory card 120. The host 110 transfer the content, which contains the lifetime information command and the argument, to the memory card 120.

The memory card 120 includes a nonvolatile memory (not shown) and a memory controller (not shown). The nonvolatile memory is formed of a NAND or NOR flash memory. The memory controller operates to control an overall operation such a read or write operation of the nonvolatile memory under control of the host 110.

The memory card 120 transfer a specific response signal 140 to the host 110 in response to the lifetime information command provided from the host 110. Referring to FIG. 5C, the specific response signal 140 includes the same lifetime information command as in the specific command 130. Further, the specific response signal 140 includes lifetime information.

The lifetime information is information provided to the host 110, including information about a usage rate of the memory card 120, in response to the lifetime information command of the host 110. The memory card 120 provides the host 110 with the lifetime information such as a kind, a use term, a usage rate, and a version of the flash memory.

The memory card 120 includes a lifetime information storage unit 121 for storing the lifetime information thereof. The lifetime information of the memory card 120 may be stored in a memory (not shown) of the memory card 120 or as illustrated in FIG. 5A, in the additional storage unit 121.

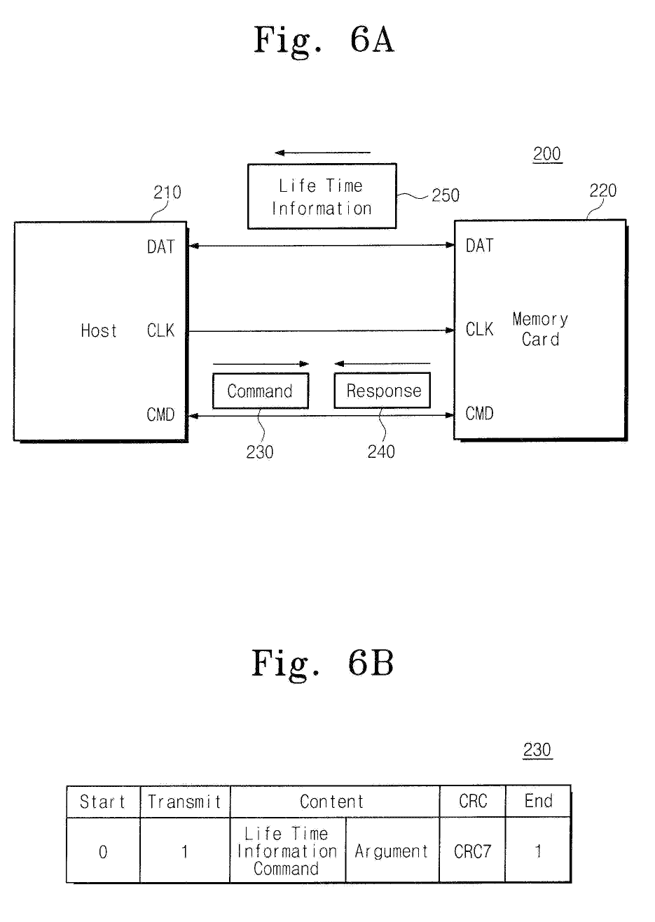

FIGS. 6A and 6B show an embodiment of transferring lifetime information in a memory card system according to the present invention. Referring to FIG. 6A, the memory card system 200 includes a host 210 and a memory card 220. The host 210 is electrically connected with the memory card 220 by way of a data line, a clock line, and a command line. A system and method of transferring a lifetime information command 230 to the memory card 220 from the host 210 is substantially the same as the exemplary embodiment illustrated by FIGS. 5A through 5C.

In the memory system shown in FIG. 5A, the specific response signal 140 transfers lifetime information using predetermined bits (e.g., 32 bits). If lifetime information is larger than a specific region (Status) of the specific response signal 140, e.g., over 32 bits, the lifetime information may not be transferred in a single unit response signal. In this case, the memory card system 200, according to an embodiment of the present invention, transfers the lifetime information by means of the data line.

The host 210 transfers the specific command 230 to the memory card 220 through the command line for requesting lifetime information. As shown in FIG. 6B, the specific command 230 contains a lifetime information command. In the memory card system shown in FIG. 6A, the memory card 220 transfers lifetime information to the host 210 through the data line.

During a transfer using the data line, for security of lifetime information, the lifetime information may be compressed using a password, encoded using a coded algorithm, etc. Further, the information of the memory card 220 may be stored in a memory (not shown) of the memory card 220 or as shown in FIG. 5A, in an additional storage unit.

The memory card system according to an embodiment of the present invention conducts a process of transferring the lifetime information during or after initialization. The lifetime information is transferred through the command or data line. According to an embodiment of the present invention, since the host identifies the lifetime information of the memory card prior to a memory card failure, a lifetime of the memory card may be extended using lifetime management processes such as wear leveling with knowledge of the lifetime information, eventual failure due to an end of lifetime may be anticipated, etc.

By the memory card system according to an embodiment of the present invention, the host provides the memory card with the lifetime information command and the memory card provides the host with the lifetime information of the memory in response to the lifetime information command. The lifetime information of the memory card is known prior to memory card failure. The lifetime information may be incorporated into the management of the memory card for improving a lifetime thereof.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A memory card system comprising:
a host generating a lifetime information command; and
a memory card including a memory to store data provided from the host, the memory card providing the host with lifetime information of the memory in response to the lifetime information command of the host.

2. The memory card system as set forth in claim 1, wherein the memory card is a Secure Digital card.

3. The memory card system as set forth in claim 1, wherein the memory card is a Multi-Media Card.

4. The memory card system as set forth in claim 1, wherein the host transfers the lifetime information command to the memory card through a command line.

5. The memory card system as set forth in claim 1, wherein the memory card transfers the lifetime to the host through a command line.

6. The memory card system as set forth in claim 1, wherein the memory card transfer the lifetime information to the host through a data line.

7. The memory card system as set forth in claim 1, wherein the memory card comprises a lifetime information storage unit for storing the lifetime information of the memory.

8. The memory card system as set forth in claim 1, wherein the memory card stores the lifetime information into the memory.

9. The memory card system as set forth in claim 1, wherein the memory is a NAND flash memory.

10. The memory card system as set forth in claim 1, wherein the memory is a NOR flash memory.

11. A method for transmitting lifetime information in a memory card system including a host and a memory card having a memory for storing data from the host, the method comprising:
transferring a command for requesting lifetime information from the memory card by the host; and
providing the host with the lifetime information of the memory in response to the command.

12. The method as set forth in claim 11, further comprising providing the memory card as a Secure Digital card.

13. The method as set forth in claim 11, further comprising providing the memory card as a Multi-Media Card.

14. The method as set forth in claim 11, wherein the host transfers the command to the memory card through a command line.

15. The method as set forth in claim 11, wherein the memory card transfers the lifetime information to the host through a command line.

16. The method as set forth in claim 11, wherein the memory card transfers the lifetime information to the host through a data line.

17. The method as set forth in claim 11, wherein the lifetime information of the memory is stored into the memory.

18. The method as set forth in claim 11, wherein the lifetime information of the memory is stored in a lifetime information storage unit of the memory card.
